(19) United States
(12) Patent Application Publication
(10) Pub. No.: US 2026/0239399 A1
(43) Pub. Date: Aug. 13, 2026

(54) NR Sidelink Resource Selection Based on LTE Sidelink Information

(71) Applicant: Apple Inc., Cupertino, CA (US)

(72) Inventors: Chunxuan YE, San Diego, CA (US); Ankit BHAMRI, Haar (DE); Chunhai YAO, Beijing (CN); Dan WU, Beijing (CN); Dawei ZHANG, Saratoga, CA (US); Haitong SUN, Saratoga, CA (US); Hong HE, San Jose, CA (US); Jie CUI, San Jose, CA (US); Seyed Ali Akbar FAKOORIAN, San Diego, CA (US); Wei ZENG, Saratoga, CA (US)

(21) Appl. No.: 19/154,197

(22) PCT Filed: Feb. 8, 2023
(86) PCT No.: PCT/CN2023/075071

§ 371 Date: Aug. 6, 2025

(51) Int. Cl. H04W 72/40; H04W 72/542; H04W 72/566

(52) U.S. Cl. CPC H04W 72/40; H04W 72/542; H04W 72/569

(57) ABSTRACT

A user equipment (UE) is configured to communicate with other UEs via a legacy sidelink (SL) connection and a non-legacy SL connection. The UE is further configured to receive legacy SL resource information associated with legacy resources in an legacy resource pool for legacy SL transmissions to be performed by the UE, wherein the legacy SL resource information comprises time location of the legacy resources and resource reservation periods and exclude non-legacy resources of a non-legacy SL resource pool for transmitting non-legacy SL transmissions based on at least the legacy resource information.

### TECHNICAL FIELD

The present disclosure generally relates to wireless communication, and in particular, to NR sidelink resource selection based on LTE sidelink information.

### BACKGROUND

A user equipment (UE) may be configured with multiple communication links. For example, the UE may receive a signal from a cell of a corresponding network over a downlink and may transmit a signal to the cell of the corresponding network over an uplink. The UE may also be configured to communicate with a further UE via a sidelink (SL). The term sidelink refers to a communication link that may be utilized for device-to-device (D2D) communication. Thus, the SL may facilitate communication between the UE and the further UE without the use of a cell.

As radio access technology (RAT) evolves, a UE may be able to communicate using protocols for multiple different RATS, e.g., Long Term Evolution and 5G New Radio (NR). Both of these RATs support SL communications but in different manners. Thus, co-channel coexistence schemes should be defined to allow a UE to perform both 5G and LTE SL transmissions.

### SUMMARY

Some exemplary embodiments are related to a method performed by a user equipment (UE) configured to communicate with other UEs via a legacy sidelink (SL) connection and a non-legacy SL connection. The method includes receiving legacy SL resource information associated with legacy resources in an legacy resource pool for legacy SL transmissions to be performed by the UE, wherein the legacy SL resource information comprises time location of the legacy resources and resource reservation periods and excluding non-legacy resources of a non-legacy SL resource pool for transmitting non-legacy SL transmissions based on at least the legacy resource information.

Other exemplary embodiments are related to a method performed by a user equipment (UE) configured to communicate with other UEs via a legacy sidelink (SL) connection and a non-legacy SL connection. The method includes receiving legacy SL resource information associated with legacy resources in an legacy resource pool for legacy SL transmissions and excluding non-legacy resources of a non-legacy SL resource pool for transmitting non-legacy SL transmissions based on at least the legacy resource information,

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary method for performing a sidelink resource selection operation according to various exemplary embodiments.

FIG. 4 illustrates a timing diagram for performing resource exclusion based on information related to LTE sidelink transmissions of the UE according to various exemplary embodiments.

FIG. 5 illustrates a timing diagram for an exemplary resource exclusion operation based on non-monitored LTE sidelink transmissions according to various exemplary embodiments.

FIG. 6 illustrates a timing diagram for an exemplary resource exclusion operation when the sub-carrier spacing (SCS) of the NR sidelink is higher than the SCS of the LTE sidelink according to various exemplary embodiments.

FIG. 7a shows a timing diagram illustrating a first exemplary manner of using multi-slot transmissions when the SCS of the NR sidelink is higher than the SCS of the LTE sidelink according to various exemplary embodiments.

FIG. 7b shows a timing diagram illustrating a second exemplary manner of using multi-slot transmissions when the SCS of the NR sidelink is higher than the SCS of the LTE sidelink according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) selecting non-legacy (e.g., 5G New Radio (NR)) sidelink (SL) resources based on at least information shared by a legacy (e.g., Long-Term Evolution (LTE)) sidelink module related to LTE SL transmissions by the UE or other UEs.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a sidelink (SL). The term “sidelink” generally refers to a communication link between the UE and a further UE. The SL provides direct device-to-device (D2D) communication where information and/or data exchanged between the UE and the further UE via the sidelink does not go through a cell. In some configurations, a single sidelink provides bidirectional data communication between the UE and the further UE. In other configurations, a single sidelink provides unidirectional data communication between the UE and the further UE, although signaling may be transmitted in both directions. The term “unicast” refers to one-to-one, i.e., D2D, device communication and generally may refer to either bidirectional or unidirectional communication. Various embodiments may apply to either one or both forms of communication as indicated below.

In some exemplary embodiments, the SL transmissions may occur in the unlicensed spectrum. As used herein, a unlicensed spectrum may include, but is not limited to, a spectrum in which spectrum access is contention based, e.g., Listen Before Talk (LBT) operations.

SL communications are supported by both Long-Term Evolution (LTE) and 5G new radio (NR) standards. In some configurations, the network may provide information to the UE that indicates how a SL connection is to be established, maintained and/or utilized. Thus, while the information and/or data exchanged over the SL does not go through a cell, the UE and the network may exchange information associated with the SL. In other configurations, the SL connection is not under the control of the network. In either configuration, the first UE and the second UE may still perform synchronization procedures, discovery procedures and exchange control information corresponding to the SL connection.

In NR sidelink transmission, two modes of resource allocations schemes are supported for vehicle-to-everything (V2X) packet transmissions. In the first mode (mode 1), the base station (gNB) schedules sidelink resources that require the UE to obtain resource information from the gNB each time a V2X communication is initiated over SL. The second mode is performed autonomously by the UE. For example, in the second mode (mode 2) resource allocation scheme, the transmission (Tx) UE selects the SL transmission resources based on its own sensing and resource selection procedure without any information from receiving (Rx) UE. In the exemplary embodiments, the second mode of resource allocation may be referenced. Additionally, in NR V2X, the resource selection procedure may perform a series of operations to identify candidate resources during the resource selection procedure. These operations will be described in more details below.

While the exemplary embodiments are described with reference to V2X, LTE and 5G, it should be understood that the exemplary embodiments are not limited to these examples. For example, the exemplary embodiments may be applied to any SL transmissions, not only V2X SL transmissions. In other examples, the principles described herein for using LTE SL information in selecting NR SL resources may also be applied for using SL information from any legacy protocol in selecting SL resources for a non-legacy protocol. That is, throughout this description, the term LTE may be regarded as meaning any legacy protocol and the term NR may be regarded as meaning any non-legacy protocol. As the cellular communications evolve, NR may become a legacy protocol and a newly introduced Sixth Generation (6G) protocol may be a non-legacy protocol. Thus, when performing 6G SL communications, the 6G sidelink module may obtain information from legacy sidelink modules (e.g., LTE and 5G) for selecting SL resources.

The exemplary embodiments are related to the NR SL module obtaining additional SL information from an LTE SL module when performing the resource selection procedure. The LTE sidelink and the NR sideline may share the same time and frequency resources in a dynamic resource pool. Thus, in the exemplary embodiments, mechanisms for co-channel coexistence between the LTE sidelink and NR sidelink may be defined for both channels to accommodate dynamic resource pool sharing between the LTE sidelink and the NR sidelink. Thus, an LTE sidelink module of the LTE sidelink may share candidate information to the NR sidelink module to prevent both the LTE sidelink and the NR sidelink from using the same frequency and time resources in the same resource pool. Accordingly, the NR sidelink module may use this shared information from the LTE sidelink module to select resources that are available for transmission.

The exemplary embodiments introduce techniques for performing resource exclusion based on information shared by the LTE sidelink module to the NR sidelink module. In one example, the UE may be configured to perform a resource exclusion technique based on the UEs own LTE sidelink transmissions. In another example, the UE may be configured to perform a resource exclusion technique based on non-monitored LTE sidelink transmissions. In a further example, the UE may be configured to perform a resource exclusion technique by handling logical subframes or slots from the LTE and NR sidelink. In another example, the UE may be configured to perform a resource exclusion technique by handling higher SCS of the NR sidelink based on the information shared by the LTE sidelink module. The exemplary techniques described herein may be used in conjunction with currently implemented techniques related to NR sidelink transmissions, future implementations of techniques related to NR sidelink transmissions and independently from other techniques related to NR sidelink transmissions.

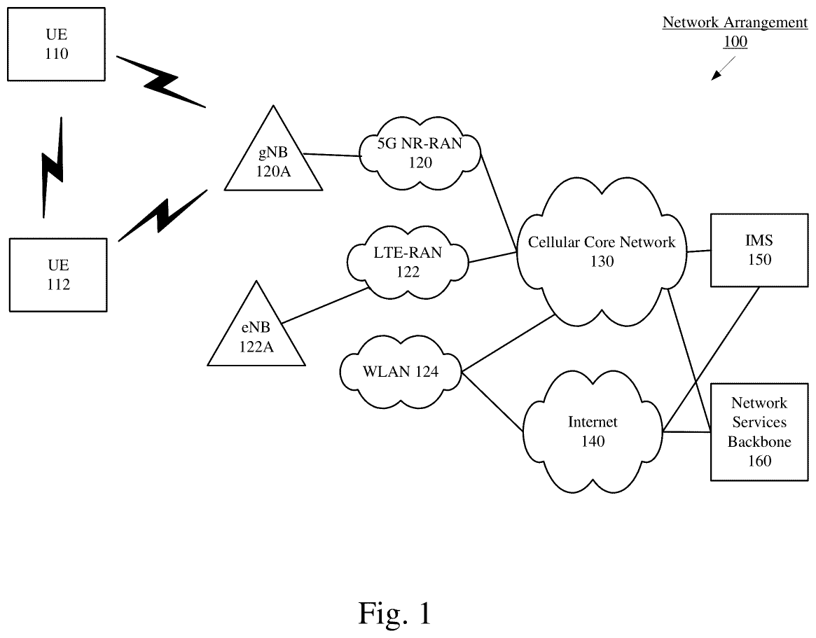

FIG. 1 shows an exemplary network arrangement 100 according to various exemplary embodiments. The exemplary network arrangement 100 includes UEs 110, 112. Those skilled in the art will understand that the UEs 110, 112 may be any type of electronic component that is configured to communicate via a network, e.g., a component of a connected car, a mobile phone, a tablet computer, a smartphone, a phablet, an embedded device, a wearable, an Internet of Things (IoT) device, etc.

Throughout this description, the terms UE 110, UE and transmitting device may be used interchangeably. Additionally, the terms UE 112, further UE and receiving device may be also used interchangeably. It should also be understood that an actual network arrangement may include any number of UEs being used by any number of users. Thus, the example of two UEs 110, 112 is merely provided for illustrative purposes.

The UEs 110, 112 may communicate directly with one or more networks. In the example of the network configuration 100, the networks with which the UEs 110, 112 may wirelessly communicate are a 5G NR radio access network (5G NR-RAN) 120, an LTE radio access network (LTE-RAN) 122 and a wireless local access network (WLAN) 124. These types of networks support vehicle-to-everything (V2X) and/or sidelink communication. In the exemplary network arrangement 100, the UEs 110 and 112 may be connected via sidelink. However, the UE 110 may also communicate with other types of networks and the UE 110 may also communicate with networks over a wired connection. Therefore, the UEs 110, 112 may include a 5G NR chipset to communicate with the 5G NR-RAN 120, an LTE chipset to communicate with the LTE-RAN 122 and an ISM chipset to communicate with the WLAN 124.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UEs 110, 112 may connect to the 5G NR-RAN via the gNB 120A. Reference to a single gNB 120A is merely for illustrative purposes. The exemplary embodiments may apply to any appropriate number of gNBs. The UEs 110, 112 may also connect to the LTE-RAN 122 via the eNB 122A.

Those skilled in the art will understand that any association procedure may be performed for the UEs 110, 112 to connect to the 5G NR-RAN 120 and the LTE-RAN 122. For example, as discussed above, the 5G NR-RAN 120 and the LTE-RAN 122 may be associated with a particular cellular provider where the UEs 110, 112 and/or the user thereof has a contract and credential information (e.g., stored on a SIM card). Upon detecting the presence of the 5G NR-RAN 120, the UEs 110, 112 may transmit the corresponding credential information to associate with the 5G NR-RAN 120. More specifically, the UEs 110, 112 may associate with a specific base station (e.g., the gNB 120A of the 5G NR-RAN 120, the eNB 122A of the LTE-RAN 122).

The UEs 110, 112 may also communicate with one another directly using a sidelink. The sidelink is a direct device-to-device (D2D) communication link. Thus, the information and/or data transmitted directly to the other endpoint (e.g., the UE 110 or the UE 112) does not go through a cell (e.g., gNB 120A, eNB 122A). In some embodiments the UEs 110, 112 may receive information from a cell regarding how the sidelink is to be established, maintained and/or utilized. Thus, a network (e.g., the 5G NR-RAN 120, LTE-RAN 122) may control the SL. In other embodiments, the UEs 110, 112 may control the sidelink. Regardless of how the sidelink is controlled, the UEs 110, 112 may maintain a downlink/uplink to a currently camped cell (e.g., qNB 120A, eNB 122A) and a SL to the other UE simultaneously.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network, e.g., the 5GC in NR. The cellular core network 130 also manages the traffic that flows between the cellular network and the Internet 140.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

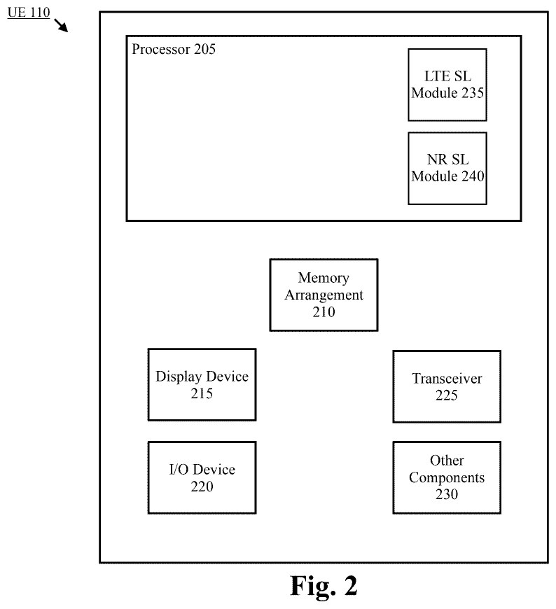

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225, and other components 230. The other components 230 may include, for example, a SIM card, an embedded SIM (eSIM), an audio input device, an audio output device, a power supply, a data acquisition device, ports to electrically connect the UE 110 to other electronic devices, etc. The UE 110 illustrated in FIG. 2 may also represent the UE 112.

The processor 205 may be configured to execute a plurality of engines of the UE 110. For example, the engines may include an LTE sidelink module 235 and a 5G NR sidelink module 240. As will be described below, the LTE sidelink module 235 may be operable to share information to the NR sidelink module 240. The 5G NR sidelink module 240 may perform resource exclusion based on the information shared by the LTE sidelink module 235. These operations are described in greater detail below.

The above referenced engines each being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the WLAN 122, etc. Accordingly, the transceiver 225 may operate on a variety of different frequencies or channels (e.g., set of consecutive frequencies).

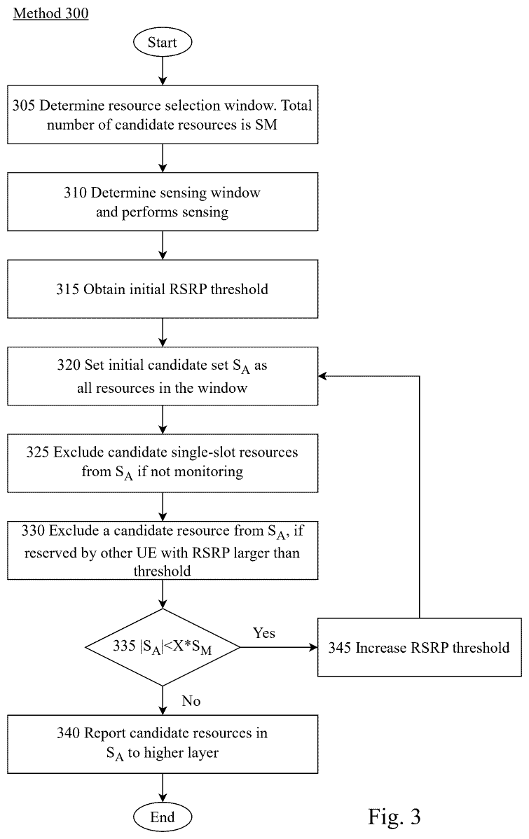

FIG. 3 shows an exemplary method 300 for performing a sidelink resource selection operation according to various exemplary embodiments. FIG. 3 will be described with regard to the network arrangement 100 of FIG. 1 and the UE 110 of FIG. 2.

In 305, the UE 110 may be configured to determine the resource selection window in the sidelink transmission with the total number of candidate resources in the resource transmission. In the exemplary embodiments, the total number of candidate resources may be represented by SM.

In 310, the UE 110 determines the sensing window and performs sensing within the sensing window to determine the reserved resources.

In 315, the UE 110 may be configured to obtain the initial reference signal received power (RSRP) thresholds based on the quality of service (QoS) of the sidelink data that is to be transmitted, e.g., the quality of the resources that are suited to transmit the SL data.

In 320, the UE 110 may be configured to set the initial candidate set S_{A} as all the resources in the sensing window that have been identified by the UE 110.

In 325, the UE 110 may be configured to exclude candidate single-slot resources from the S_{A} if the UE 110 is unable to monitor the resources during the sensing that is performed in the sensing window. In the exemplary embodiments, if the UE 110 is unable to perform sensing in the slot of the sensing time window, the UE 110 may be unable to detect resource reservations within the slot. Accordingly, the UE 110 is unable to determine whether the slot has a resource reservation and therefore may be configured to exclude the slot.

In 330, the UE 110 may be configured to exclude a candidate resource from the S_{A} if the UE 110 determines that the candidate resources have been reserved by other UEs with RSRP larger than the threshold value previously defined.

In 335, if the UE 110 determines that the number of resources in S_{A} is less that the total number of candidate resources (X*Mₜₒₜₐₗ), the UE 110 may be configured to increase the RSRP threshold in 345 and return to 320. It should be understood that the value X Mₜₒₜₐₗ is some percentage of the total number of resources, e.g., Mₜₒₜₐₗ is the total number of resources and X is a value 0<X<1. This threshold value may be preconfigured or set based on any relevant factor.

Otherwise, in 340, the UE 110 may be configured to report the candidate resources in S_{A} to the higher physical layer.

As described above, when a UE is capable of performing both non-legacy (e.g., NR) and legacy (e.g., LTE) sidelink communications, the legacy and non-legacy sidelink communications may share a dynamic resource pool. Thus, in the exemplary embodiments a UE may perform the exclusion operations (e.g., 325, 330) based on, at least in part, information obtained by the non-legacy sidelink module from the legacy sidelink module of the UE. The manner of the legacy sidelink module sharing the information and the type of information that is shared by the legacy sidelink module is described by way of example in further detail below.

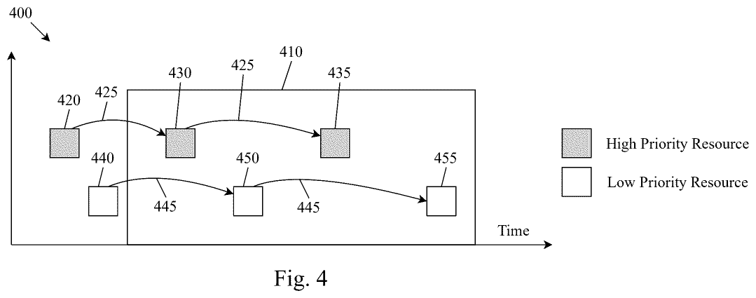

FIG. 4 illustrates a timing diagram 400 for performing resource exclusion based on information related to LTE sidelink transmissions of the UE 110 according to various exemplary embodiments. FIG. 4 will be described with regard to the network arrangement 100 of FIG. 1, the UE 110 of FIG. 2 and the method of FIG. 3. In the example of FIG. 4, the x-axis is the time domain but the y-axis is not the frequency domain, e.g., while the resources 420, 430, 435 are shown above the resources 440, 450, 455 there is no requirement that the resources 420, 430, 435 be a different frequency than the resources 440, 450, 455.

In the example of FIG. 4, the UE 110 may be configured to operate autonomously during an NR sidelink operations to exclude resources based on information concerning LTE sidelink transmissions performed by the UE 110, e.g., the LTE sidelink transmissions and the NR sidelink transmissions are to be performed by the same UE 110. Thus, the LTE sidelink module 235 of the UE 110 will share the information with the NR sidelink module 240 of the UE 110 and the NR sidelink module 240 may then use this information when performing the exclusion operations.

Initially, the information related to the LTE sidelink transmission resources may include resources that have been reserved and/or selected by the UE 110. In the exemplary embodiments, it may be considered that a selected resource is a resource on which the UE 110 intends to transmit SL data, whereas a reserved resource is a resource that the UE 110 reserves for a future SL transmissions but that transmission may or may not be performed, e.g., a retransmission. In some exemplary embodiments, the LTE sidelink module 235 may share information for both reserved resources and selected resources. In some exemplary embodiments, the LTE sidelink module 235 may share information for only reserved resources.

In some exemplary embodiments, the information that is shared by the LTE sidelink module 235 with the NR sidelink module 240 may include time location of resources and resource reservation periods for the LTE SL communications. In these exemplary embodiments, the LTE sidelink module 235 may omit reporting the frequency location of resources. This is because the UE 110 may be configured to perform only an LTE SL transmission or an NR SL transmission in a particular subframe. Thus, once the NR sidelink module 240 understand that an LTE SL transmission is to occur in particular resource (in time), that resource may be excluded from the NR resource set regardless of the location in the frequency domain.

Additionally, the information may also include Cᵣₑₛₑₗ which is any periodic extension of the LTE sidelink resources. This information informs the NR sidelink module 240 of the number of resources that will be selected subsequently by the LTE sidelink module 235.

To provide an example of the exclusion operation based on the above described exemplary embodiments, in FIG. 4, it may be considered that there is an NR resource selection window 410. The LTE sidelink module 235 may report the time location of resources and resource reservation periods for the LTE SL communications of the UE 110 to the NR sidelink module 240. As described above, this information may be for reserved resources and selected resources or for only reserved resources. In this example, the time location of a first LTE SL resource 420 may be reported to the NR sidelink module 240 along with the resource reservation period illustrated as 425 in FIG. 4 and a Cᵣₑₛₑₗ value of 2. Thus, the NR sidelink module 240 will understand that the LTE SL resources 430 and 435 fall within the NR resource selection window 410. In this example, the time location of a second LTE SL resource 440 may be reported to the NR sidelink module 240 along with the resource reservation period and a Cᵣₑₛₑₗ value of 2 as also illustrated as 445 in FIG. 4. Thus, the NR sidelink module 240 will understand that the LTE SL resources 450 and 455 also fall within the NR resource selection window 410. For the purposes of this example, the priority of the LTE SL resources may be ignored as the priority will be described in greater detail below (e.g., the priority information is not used for exclusion operations in this example).

As described above, this information concerning the LTE SL resources may be used by the NR sidelink module 240 when performing the resource selection procedure, specifically when excluding certain resources from the candidate resources for NR SL transmissions. When the NR sidelink module 240 may perform this exclusion operation based on the LTE SL resource information in the context of the method 300 will be described in greater detail below. In the example started above, the NR sidelink module 240 may exclude the resources (e.g., subframes) that correspond to the LTE SL resources 430, 435, 450 and 455 that fall within the NR resource selection window 410 from the candidate resources for the NR SL transmissions.

The above example may be generalized to an exclusion rule that states the NR sidelink module 240 always excludes the resources in the slots which have time overlap with LTE sidelink resources, irrespective of the the priority of LTE sidelink transmissions and NR sidelink transmissions.

In other exemplary embodiments, the information that is shared by the LTE sidelink module 235 with the NR sidelink module 240 may include time location of resources, resource reservation periods and priority for the LTE SL communications. Again, the LTE sidelink module 235 may omit reporting the frequency location of resources for the same reasons as described with reference to the above examples.

To provide an example of the exclusion operation based on the above described exemplary embodiments, FIG. 4 may again be considered. FIG. 4 was already described above and will not be described again, except to note that the LTE SL resources 430 and 435 that fall within the NR resource selection window 410 have a high priority and the LTE SL resources 450 and 455 that fall within the NR resource selection window 410 have a low priority.

In this example started above, when the NR sidelink module 240 performs the exclusion operation, the resources (e.g., subframes) that correspond to the high priority LTE SL resources 430 and 435 may be excluded from the candidate resources for the NR SL transmissions, while the low priority LTE SL resources 450 and 455 may not be excluded from the candidate resources for the NR SL transmissions.

The above example may be generalized to an exclusion rule that states that the NR sidelink module 240 only excludes the resources in the slots which have time overlap with the LTE sidelink resources when the NR sidelink data priority is lower than the LTE sidelink data priority. That is, in the above example, it was considered that the high priority LTE SL resources 430 and 435 were for LTE SL data that had a higher priority than the NR SL data and therefore NR sidelink module 240 excluded these resources from the candidate resources for the NR SL transmissions. On the other hand, it was considered that the low priority LTE SL resources 450 and 455 were for LTE SL data that had a lower priority than the NR SL data and therefore NR sidelink module 240 did not exclude these resources from the candidate resources for the NR SL transmissions. In some exemplary embodiments, the SL data (NR or LTE) may be labelled with a priority value and the exclusion rule defined above may be applied based on the corresponding priority values. In some exemplary embodiments, the lower the priority value, the higher the data priority.

In the exemplary embodiments, the NR sidelink module 240 may implement the above resource exclusion rules, for example, immediately before 325 in the method 300, immediately after 325 or immediately after 330. After the exclusion of the resources, e.g., the LTE SL resource exclusion and the exclusions described above with reference to 325 and 330, the resource selection operation may then continue to 335 to determine if the number of candidate single-slot resources R_{x,y} remaining in the set S_{A} is smaller than the X*Mₜₒₜₐₗ. As describes above, when S_{A} is smaller than the X*Mₜₒₜₐₗ, the NR sidelink module 240 may increase the RSRP value and initialize the set S_{A} to the set of all candidate single slot resources as described in 320 of the method 300.

In some exemplary embodiments, the NR sidelink module 240 may exclude the LTE SL resources one at a time rather than for the entire NR resource selection window 410. For example, the NR sidelink module 240 may apply one of the above described rules for excluding LTE SL resources. However, the rule may be applied for as each applicable LTE SL resource is encountered, e.g., starting from the highest priority SL resource. Again, referring to FIG. 4, the first highest priority LTE SL resource is LTE SL resource 430. Thus, the NR sidelink module 240 will apply the applicable exclusion rule to this LTE SL resource. In this example, it may be considered that the first exclusion rule is applied, e.g., the NR sidelink module 240 excludes all LTE SL resources from the NR candidate SL resources. Thus, the NR sidelink module 240 will exclude the LTE SL resource 430 from the NR candidate SL resources.

However, instead of progressing to the next LTE SL resource to see if that resource should be excluded, the NR sidelink module 240 will progress to 335 to determine if excluding the LTE SL resource 430 results in the number of candidate single-slot resources R_{x,y} remaining in the set S_{A} being smaller than the X*Mₜₒₜₐₗ. If S_{A} is smaller than the X*Mₜₒₜₐₗ, then the NR sidelink module 240 will reduce the RSRP value and return to 420 to begin the resource selection process again with the higher RSRP value. If S_{A} is not smaller than the X*Mₜₒₜₐₗ, then the NR sidelink module 240 will determine if the next highest priority LTE SL resource (e.g., LTE SL resource 435 in FIG. 4) should be excluded and continue this process until either S_{A} is smaller than the X*Mₜₒₜₐₗ or all the LTE SL resources are treated.

The exclusion rule implemented by the NR sidelink module 240 and the order of applying the exclusion rule may be based on resource pool (pre) configuration or UE implementation.

In some exemplary embodiments, the information provided by the LTE sidelink module 235 to the NR sidelink module 240 is that a particular LTE SL resource is not monitored, e.g., the LTE sidelink module 235 is not aware if any other UEs are transmitting on the particular LTE SL resource. As described above, the NR sidelink module 240 excludes non-monitored resources in 325 but these are NR SL resources being used by other UEs. The issue presented in these exemplary embodiments in the treatment by the NR sidelink module 240 of non-monitored LTE SL resources which is based on the information provided by the LTE sidelink module 235.

In the exemplary embodiments, the NR sidelink module 240 may exclude any candidate single-slot resource Rx, y from the set S_{A} if it meets any of the following conditions. A first condition is the UE 110 fails to monitor the subframe

$${t}_{m}^{′ SL}$$

in the LTE sidelink. A second condition is that the periodicity value allowed by the LTE sidelink parameters restrictRespurceReservationPeriod and a hypothetical Sidelink Control Information (SCI) format 1 received in subframe

$${t}_{m}^{′ SL}$$

with a ‘Resource reservation period’ field. A third condition is if the number of R_{x,y} from the set S_{A} is smaller than X*Mₜₒₜₐₗ as described in 320, then the UE 110 may initialize the set S_{A} to the set of all the candidate single-slot resources as described at the beginning of 320. Thus, once these conditions are met, the UE 110 may exclude any candidate single-slot resource R_{x,y} from the set S_{A}.

Those skilled in the art will understand that these features may be based on the resource pool (pre) configuration or UE 110 implementation. For example, if there is high priority NR sidelink data to be transmitted, then the UE 110 may want to identify the non-monitored LTE sidelink as exclusions to avoid any transmission conflict between the NR sidelink data transmission of the UE 110 and potential LTE sidelink transmissions of other UEs. Accordingly, this feature may be enabled based on the NR sidelink data priority. For instance, for NR sidelink data with high priority higher than a certain threshold, this feature of the UE 110 may be enabled. However, if the NR sidelink data has a priority lower than the set threshold, this feature may be disabled.

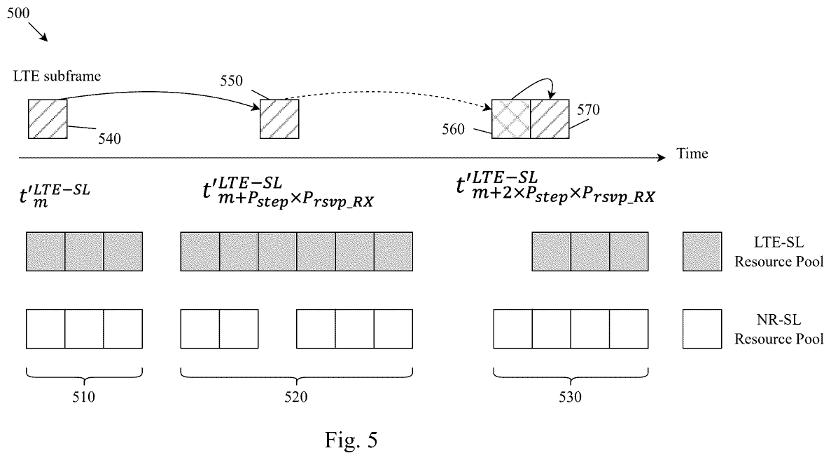

FIG. 5 illustrates a timing diagram 500 for an exemplary resource exclusion operation by handling logical subframes from LTE and NR sidelink according to various exemplary embodiments. FIG. 5 will be described with regard to the network arrangement 100 of FIG. 1, the UE 110 of FIG. 2 and the method of FIG. 3.

In FIG. 5, the LTE sidelink resource pool resources and the NR sidelink resource pool resources are shown as being in slots 510-530. It should be understood that both the LTE SL resources and NR SL resources may not include every subframe in the slot. For example, in FIG. 5, the slot 520 includes a subframe that is not the NR SL resource pool and the slot 530 includes a subframe that is not in the LTE SL resource pool. It should be understood that the representation of FIG. 5 is only for illustrative purposes and the length of the slots and the number of subframes in a slot are typically defined by standard (e.g., 3GPP standards for the licensed band and IEEE standards for the unlicensed bands). However, the exemplary embodiments are not limited by slot length or the number of subframe sin a slot.

The UE 110 may handle the logical subframes or slots by implementing various exemplary techniques. In some exemplary embodiments, the UE 110 may decode the sidelink control information (SCI) to logically handle the sidelink data in both the LTE and NR sidelink. Those skilled in the art will understand that SCI comprises information that allows UEs to receive sidelink communications. For example, if the UE 110 decodes the SCI at

$${t}_{m}^{′ LTE - SL} ,$$

where the resource reservation periodicity is given by

$${P}_{rsvp \_ RX}^{LTE} ,$$

then the UE 110 may be configured to perform operations based on the resource reservation periodicity. For example, the UE 110 may determine from the information in the SCI that there is an LTE SL subframe 540 and as described above a resource reservation periodicity related to the LTE subframe 540. In exemplary operations, the UE 110 may convert the periodic extension of the LTE resource reservation to LTE sidelink logical subframes. For example, if the subframe

$$m + q \times {P}_{step} \times {P}_{rsvp \_ RX}^{LTE}$$

is within the LTE sideline resource pool, then the subframe is considered as the periodic extension. This is shown in FIG. 5 as the first periodic extension from the subframe 540 to the subframe 550. In this example, the subframe 550 is in the LTE SL resource pool meaning that the subframe 550 is considered a periodic extension. However, alternatively, if the subframe

$$m + q \times {P}_{step} \times {P}_{rsvp \_ RX}^{LTE}$$

is not within LTE sidelink resource pool, then it is the first subframe within the LTE sidelink resource pool after the subframe

$$m + q \times {P}_{step} \times {P}_{rsvp \_ RX}^{LTE} .$$

This is shown in FIG. 5 as the periodic extension to subframe 560. The subframe 560 is not in the LTE SL resource pool meaning that the subframe 560 is not considered a periodic extension but the first subframe after the subframe 560 that is in the LTE SL resource pool (e.g., the subframe 570) is considered a periodic extension.

The UE 110 may then check the time overlap of the converted LTE logical subframes with the NR sidelink resource pool once the SCI is decoded. Once the affected NR sidelink resources have been identified, the UE 110 may exclude the corresponding NR sub-channels whose frequency domain may be overlapping with the LTE sidelink resources under certain conditions such as high measured RSRP value, etc. This is illustrated in FIG. 5 where the LTE subframe 550 does not overlap with the NR resource pool but LTE subframe 570 does overlap with the NR resource pool.

In other exemplary embodiments, the UE 110 may handle the logical subframes from the LTE and the NR sidelink by implementing a technique that determines if the non-monitored LTE subframes or an LTE sidelink transmission by the UE 110 is at

$${t}_{m}^{′ LTE - SL} ,$$

where the resource reservation periodicity is given by

$${P}_{rsvp \_ TX}^{LTE} .$$

These exemplary embodiments may also be illustrated by FIG. 5, but in these examples, the subframes 540-570 are non-monitored subframes or subframes in which the UE 110 is transmitting LTE SL data. First, the UE 110 may convert the periodic extension of its own LTE resource reservation or non-monitored LTE subframe to LTE sidelink logical subframes if certain conditions are met. In one aspect, if the subframe

$$m + q \times {P}_{step} \times {P}_{rsvp \_ RX}^{LTE}$$

is within the LTE sidelink resource pool, then it is considered as the periodic extension, e.g., subframe 550. Alternatively, if the subframe

$$m + q \times {P}_{step} \times {P}_{rsvp \_ RX}^{LTE}$$

is not within the LTE sidelink resource pool (e.g., subframe 560), then the subframe is the first subframe within LTE sidelink resource pool after the subframe

$$m + q \times {P}_{step} \times {P}_{rsvp \_ RX}^{LTE}$$

(e. g., subframe 570).

The UE 110 may check the time overlap of the converted LTE logical subframes with NR sidelink resource pool. Once the affected NR sidelink logical slots have been identified, the UE 110 may exclude all the single-slot NR resources which are time domain overlapping with the sidelink transmissions of the UE 110 or non-monitored LTE subframes. This is also illustrated in FIG. 5 where the LTE subframe 550 does not overlap with the NR resource pool but LTE subframe 570 does overlap with the NR resource pool.

Under conventional circumstances, the LTE sidelink resource pool may be configured with 15 KHZ sub-carrier spacing (SCS). However, in some exemplary embodiments, the NR sidelink resource pool may be configured with a higher SCS, e.g., 30 kHz, 60 kHz, etc. This may result in reception issues in the LTE sidelink. The exemplary embodiments introduce techniques for performing the resource exclusion in the NR sidelink transmission by handling higher SCS of the NR sidelink resource pool. These are techniques are described in further detail below.

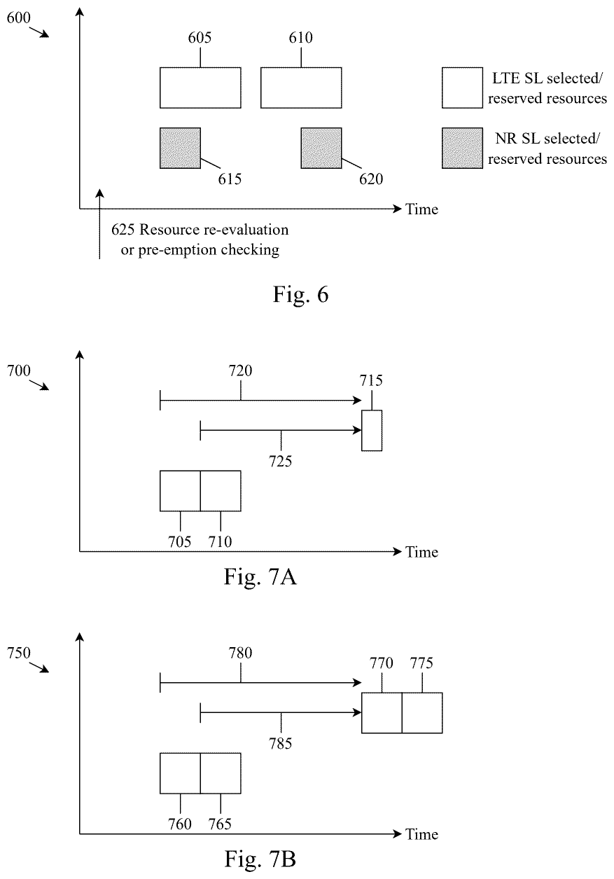

FIG. 6 illustrates a timing diagram 600 for an exemplary resource exclusion operation when the SCS of the NR sidelink is higher than the SCS of the LTE sidelink according to various exemplary embodiments. FIG. 6 will be described with regard to the network arrangement 100 of FIG. 1, the UE 110 of FIG. 2 and the method of FIG. 3.

FIG. 6 shows LTE sidelink selected and/or reserved resources 605 and 610 and NR sidelink selected and/or reserved resources 615 and 620. As shown in FIG. 6, if the LTE SL transmission on the resource 605 and the NR SL transmission is performed on resource 615, the reception of the LTE SL transmission may be affected. For example, the automatic gain control (AGC) information of the LTE SL transmission is typically included at the beginning of the transmission when the NR SL transmission is occurring. Thus, when the NR SL transmission stops, the AGC information used by the receiver of the LTE SL transmission may no longer be valid and may result in issues at the receiver of the LTE SL transmission. A similar issue may also occur when for the LTE SL transmission on the resource 610.

The exemplary embodiments provide a resource re-evaluation or pre-emption checking to consider the LTE sidelink resource reservation to consider the SCS difference between the LTE SL and the NR SL. The resource re-evaluation or pre-emption checking may be performed in the time domain only and may include two operations. In a first operation, the UE 110 may determine the NR sidelink resource selection or reservation on a slot without LTE sidelink transmissions, e.g., in a manner consistent with the above described exemplary embodiments.

In a second operation, as the NR sidelink resource selection or reservation is approaching (e.g., as shown by 625 in FIG. 6), the UE may perform a resource re-evaluation or pre-emption check. In this re-evaluation or pre-emption check, the UE 110 may detect other LTE sidelink resource reservation by other UEs or an LTE sidelink transmission resource selection by the UE 110. For example, when the UE 110 initially reserved/selected the NR sidelink resource 615, the LTE SL sidelink resource 605 may not have been selected (e.g., by the UE 110 or other UEs). However, since the initial reservation/selection of the NR sidelink resource 615, the re-evaluation or pre-emption check may reveal that the LTE SL sidelink resource may have been selected. The overlap may be in the beginning (e.g., resources 605 and 615), in the middle and/or end of the subframe (e.g., resources 610 and 620).

In some exemplary embodiments, when the overlap occurs, the UE 110 may drop the selected or reserved NR sidelink resources 615 or 620. In other exemplary embodiments, the UE 110 may extend the selected or reserved NR sidelink resources 615 or 620 to the whole subframe if the remaining slots are available. The UE 110 may extend the resources by simply copying the same contents into the available slots. However, the UE 110 may implement this operation depending on the data priority of the LTE sidelink resource reservation and the NR sidelink transmission.

In some exemplary embodiments, when the SCS of the NR sidelink is higher than the SCS of the LTE sidelink, multi-slot transmissions are used the NR SL transmissions. Multi-slot transmissions may be considered to be transmissions that are repeated in two slots. The use of multi-slot slot transmissions for NR SL may be enabled or disabled by the resource pool (pre) configuration.

FIG. 7a shows a timing diagram 700 illustrating a first exemplary manner of using multi-slot transmissions when the SCS of the NR sidelink is higher than the SCS of the LTE sidelink according to various exemplary embodiments. In the example of FIG. 7a, the x-axis is the time domain but the y-axis is not the frequency domain, e.g., while the resource 715 is shown above the resources 705 and 710 there is no requirement that the resource 715 be a different frequency than the resources 705 and 710.

In FIG. 7a, the UE 110 may perform multi-slot transmissions for NR SL. For example, the UE 110 may transmit the same contents (e.g., Physical Sidelink Control Channel (PSCCH) and/or Physical Sidelink Shared Channel (PSSCH)) in slots 705 and 710. Those skilled in the art will understand that NR SL resources will also be used for the UE 110 to receive feedback (e.g., ACK/NACK) in a Physical Sidelink Feedback Channel (PSFCH) related to the PSCCH/PSSCH multi-slot transmissions. In the example of FIG. 7a, the PSFCH is shown as slot 715.

An issue may be as to the timing of when the PSFCH 715 should be for the multi-slot transmissions. In some exemplary embodiments, the PSFCH 715 is in a slot that is a predetermined number of slots (e.g., 2 slots, 3 slots, etc.) after the first PSCCH/PSSCH slot 705 as shown by the timing line 720. In other exemplary embodiments, the PSFCH 715 is in a slot that is a predetermined number of slots (e.g., 2 slots, 3 slots, etc.) after the second PSCCH/PSSCH slot 710 as shown by the timing line 725. The location of the PSFCH 715 may be based on the resource pool (pre) configuration or on the information included in the SCI (e.g., a reserved bit in the first stage of the SCI may indicate whether the location of the PSFCH is based on the first or last PSCCH/PSSCH slot). In still further exemplary embodiments, multiple PSFCH transmissions may correspond to the multi-slot PSCCH/PSSCH transmissions 705 and 710.

FIG. 7b shows a timing diagram 750 illustrating a second exemplary manner of using multi-slot transmissions when the SCS of the NR sidelink is higher than the SCS of the LTE sidelink according to various exemplary embodiments. In the example of FIG. 7b, the x-axis is the time domain but the y-axis is not the frequency domain, e.g., while the resources 770 and 775 are shown above the resources 760 and 765 there is no requirement that the resources 770 and 775 be a different frequency than the resources 760 and 765.

Similar to FIG. 7a, in FIG. 7B the UE 110 may perform multi-slot transmissions for NR SL. For example, the UE 110 may transmit the same PSCCH/PSSCH contents in slots 760 and 765. In the example of FIG. 7b, the multi-slot transmissions are retransmitted as shown by PSCCH/PSSCH slots 770 and 775. The time gap between the PSCCH/PSSCH transmissions 760 and 765 and the PSCCH/PSSCH retransmissions 770 and 775 as may be indicated in the first stage of the SCI (e.g., the time resource assignment).

An issue may be as to how this time gap should be applied for the multi-slot transmissions. In some exemplary embodiments, the PSCCH/PSSCH retransmissions 770 and 775 occur based on the first PSCCH/PSSCH slot 760 as shown by the timing line 780. In other exemplary embodiments, the PSCCH/PSSCH retransmissions 770 and 775 occur based on the second PSCCH/PSSCH slot 765 as shown by the timing line 785. Again, the PSCCH/PSSCH retransmissions 770 and 775 timing may be based on the resource pool (pre) configuration or on the information included in the SCI (e.g., a reserved bit in the first stage of the SCI may indicate whether the timing is based on the first or last PSCCH/PSSCH slot).

### Examples

In a first example, a method is performed by a user equipment (UE) configured to communicate with other UEs via a legacy sidelink (SL) connection and a non-legacy SL connection, the method comprising receiving legacy SL resource information associated with legacy resources in an legacy resource pool for legacy SL transmissions and excluding non-legacy resources of a non-legacy SL resource pool for transmitting non-legacy SL transmissions based on at least the legacy resource information.

In a second example, the method of the first example, wherein the legacy SL resource information comprises sidelink control information (SCI) received in a first subframe of an legacy SL resource pool and a resource reservation periodicity related to the SCI, wherein the method further comprises determining a second subframe based on the first subframe and the resource reservation periodicity and determining whether the second subframe is in the legacy SL resource pool.

In a third example, the method of the second example, wherein, when the second subframe is in the legacy SL resource pool, the excluding comprises excluding corresponding sub-channels of the non-legacy resources that are frequency domain overlapping with the second subframe.

In a fourth example, the method of the second example, wherein, when the second subframe is in not in the legacy SL resource pool, the method further comprising determining a next subframe after the second subframe that is in the legacy SL resource pool, wherein the excluding comprises excluding corresponding sub-channels of the non-legacy resources that are frequency domain overlapping with the next subframe.

In a fifth example, the method of the first example, wherein the legacy SL resource information comprises a first subframe of an legacy SL resource pool that is reserved for an legacy transmission by the UE or for which the UE has not monitored whether other UEs are performing legacy SL transmissions and a resource reservation periodicity related to the first subframe, wherein the method further comprises determining a second subframe based on the first subframe and the resource reservation periodicity and determining whether the second subframe is in the legacy SL resource pool.

In a sixth example, the method of the fifth example, wherein, when the second subframe is in the legacy SL resource pool, the excluding comprises excluding non-legacy resources that overlap in time with the second subframe.

In a seventh example, the method of the fifth example, wherein, when the second subframe is not in the legacy SL resource pool, the method further comprising determining a next subframe after the second subframe that is in the legacy SL resource pool, wherein the excluding comprises excluding non-legacy resources that overlap in time with the next subframe.

In a seventh example, the method of the first example, wherein the legacy SL connection is a Long Term Evolution (LTE) SL connection and the non-legacy SL connection is a New Radio (NR) connection.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE) configured to communicate with other UEs via a legacy sidelink (SL) connection and a non-legacy SL connection, the method comprising:
receiving legacy SL resource information associated with legacy resources in an legacy resource pool for legacy SL transmissions to be performed by the UE, wherein the legacy SL resource information comprises time location of the legacy resources and resource reservation periods; and
excluding non-legacy resources of a non-legacy SL resource pool for transmitting non-legacy SL transmissions based on at least the legacy resource information.

2. The method of claim 1, wherein the legacy SL resources comprise reserved resources and selected resources.

3. The method of claim 1, wherein the legacy SL resources comprise only reserved resources.

4. The method of claim 1, wherein excluding non-legacy resources comprises excluding any non-legacy resources that overlap in time with the legacy resources.

5. The method of claim 1, wherein the legacy SL resource information further comprises priority information.

6. The method of claim 5, wherein excluding non-legacy resources comprises excluding any non-legacy resources that overlap in time with the legacy resources and where non-legacy data to be transmitted in the non-legacy resources has a lower priority than the legacy data to be transmitted in the legacy resources.

7. The method of claim 1, wherein the excluding is further based on non-legacy SL resource information, the method further comprising:
after excluding non-legacy resources of the non-legacy SL resource pool, determining whether a number of remaining resources in the non-legacy SL resource pool is less than a predetermined percentage of a total number of non-legacy resources in the non-legacy SL resource pool; and
when the number of remaining resources in the non-legacy SL resource pool is less than the predetermined percentage, resetting a reference signal received power (RSRP) threshold for the non-legacy resources for the excluding based on the non-legacy SL resource information; and
reperforming the excluding.

8. The method of claim 7, wherein the determining whether a number of remaining resources is less than the predetermined percentage of the total number of non-legacy resources is performed after all non-legacy resources are excluded based on the at least the legacy resource information.

9. The method of claim 7, wherein the determining whether a number of remaining resources is less than the predetermined percentage of the total number of non-legacy resources is performed after each non-legacy resource is excluded based on the at least the legacy resource information.

10. The method of claim 1, further comprising:
receiving further legacy SL resource information associated with legacy resources in the legacy resource pool for which the UE has not monitored whether other UEs are performing legacy SL transmissions, wherein the further legacy SL resource information comprises time location of the non-monitored legacy resources and periodicity information for the non-monitored legacy resources,
wherein the excluding non-legacy resources of the non-legacy SL resource pool for transmitting non-legacy SL transmissions is further based on at least the further legacy resource information.

11. The method of claim 10, wherein the receiving further legacy SL resource information is based on a priority of data that is to be transmitted in the non-legacy resources.

12. The method of claim 1, wherein a sub-carrier spacing (SCS) of the non-legacy resources is higher than a SCS of the legacy resources, the method further comprising:
after performing the excluding, selecting at least one of the non-legacy resources remaining in the non-legacy SL resource pool for transmitting non-legacy SL transmissions;
receiving further legacy SL resource information associated with further legacy resources in an legacy resource pool for legacy SL transmissions to be performed by the UE; and
determining whether the at least one of the non-legacy resources remaining in the non-legacy SL resource pool overlaps in time with any portion of one of the further legacy resources.

13. The method of claim 12, wherein, when the at least one of the non-legacy resources overlaps in time with any portion of one of the further legacy resources, the at least one of the non-legacy resources is excluded.

14. The method of claim 12, wherein, when the at least one of the non-legacy resources overlaps in time with a portion of one of the further legacy resources, the method further comprising:
extending the at least one of the non-legacy resources to fully overlap in time the one of the further legacy resources, wherein the extending comprises copying data that is to be transmitted in the at least one of the non-legacy resources into the extended one of the non-legacy resources.

15. The method of claim 14, wherein the extending is based on a priority of the data that is to be transmitted in the at least one of the non-legacy resources.

16. The method of claim 12, wherein data that is to be transmitted in the non-legacy resources comprise Physical Sidelink Control Channel (PSCCH) information and Physical Sidelink Shared Channel (PSSCH) information, and
wherein the PSCCH and PSSCH information is repeated in a first slot of the at least one of the non-legacy resources and a second slot of the at least one of the non-legacy resources, wherein the first slot and second slot are contiguous slots.

17. The method of claim 16, wherein the non-legacy resources comprise Physical Sidelink Feedback Channel (PSFCH) resources for providing feedback to the UE related to the transmission of the PSCCH and PSSCH information in the first and second slots,
wherein the PSFCH resources are located a predetermined number of slots after the first and second slots, and
wherein a configuration of the PSFCH resources is based on a configuration or preconfiguration of the non-legacy SL resource pool or on information received via sidelink control information (SCI).

18. The method of claim 17, wherein the configuration of the PSFCH resources comprises an indication that the PSFCH resources are located the predetermined number of slots from the first slot or the second slot.

19. The method of claim 16, wherein the PSCCH and PSSCH information transmitted in the first slot and the second slot of the at least one of the non-legacy resources is retransmitted in two further slots located a predetermined number of slots after the first and second slots, wherein the predetermined number of slots is based on the first slot or the second slot.

20. The method of claim 1, wherein the legacy SL connection is a Long Term Evolution (LTE) SL connection and the non-legacy SL connection is a New Radio (NR) connection.
